(19) United States
(12) Patent Application Publication
(10) Pub. No.: US 2008/0214972 A1
(43) Pub. Date: Sep. 4, 2008

(54) THERAPEUTIC DEVICE FOR INDUCING BLOOD PRESSURE MODULATION

(75) Inventor: Edward H. Phillips, Troy, MI (US)

Correspondence Address: GIFFORD, KRASS, SPRINKLE,ANDERSON & CITKOWSKI, P.C, PO BOX 7021, TROY, MI, 48007-7021, US

(73) Assignee: VBPM Corporation, Troy, MI (US)

(21) Appl. No.: 12/108,901

(22) Filed: Apr. 24, 2008

Related U.S. Application Data
(63) Continuation-in-part of application No. 11/961,305, filed on Dec. 20, 2007.
Application No. 11/961,305 is a continuation-in-part of application No. 11/775,507, filed on Jul. 10, 2007.
Application No. 11/775,507 is a continuation-in-part of application No. 11/749,505, now abandoned.
(60) Provisional application No. 60/848,740, filed on Oct. 2, 2006.

(51) Int. Cl. A61H 1/00; A61G 7/005

(52) U.S. Cl. 601/24; 5/610

(57) ABSTRACT

A therapeutic method and apparatus intended for enhancing blood circulation, and lymph and neural fluid flow throughout a person's body and particularly within the person's eyes. In addition, the therapeutic method and apparatus are also intended for enhancing intraocular fluid flow within the person's eyes. The person is placed supinely in a comfortable and relaxed state on a support member, such as a bed which is operated by a controllable motor driven drive mechanism. The support member tilts cyclically like a seesaw to alternatively raise the person's head about the lower extremities, and vice-versa.

### RELATED APPLICATIONS

The present application is related to U.S. patent application Ser. No. 11/209,813 filed on Aug. 16, 2005 and entitled “Rhythmic Blood Pressure Modulation and Legshaking Apparatus” that issued on Oct. 2, 2007 as U.S. Pat. No. 7,276,033, which patent (hereinafter the “'033 patent”) is expressly incorporated herein by reference. The present application is also a continuation-in-part of U.S. patent application Ser. No. 11/961,305 filed on Dec. 20, 2007 and entitled “Therapeutic Device for Inducing Blood Pressure Modulation”; which was a continuation-in-part of U.S. patent application Ser. No. 11/775,507 filed on Jul. 10, 2007 and also entitled “Therapeutic Device for Inducing Blood Pressure Modulation”; which in turn was a continuation-in-part of U.S. patent application Ser. No. 11/749,505 filed on May 16, 2007 and also entitled “Therapeutic Device for Inducing Blood Pressure Modulation” now abandoned; and claims priority of U.S. Provisional Patent Application Ser. No. 60/848,740 filed on Oct. 2, 2006 and also entitled “Therapeutic Device for Inducing Blood Pressure Modulation”.

### BACKGROUND OF THE INVENTION

The present invention relates generally to therapeutic devices and, more particularly, to a therapeutic device and a method of use therefor that is believed herein to enhance blood circulation as well as intraocular, lymph and neural fluid flows within a person's eyes with the aim of relieving symptoms of macular edema, macular degeneration, glaucoma, diabetic retinopathy, and retinal artery and vein occlusions.

Various types of devices have been used for enhancing blood flow through selected portions of human cardiovascular systems. This has been done for the purpose of alleviating various symptoms associated with different types of diseases or conditions. For example, enhanced external counter-pulsation (hereinafter “EECP”) utilizes pressure cuffs around various portions of a person's lower extremities and buttocks. The pressure cuffs are sequentially and abruptly inflated and then deflated in sync with the person's heart rate such as to implement a reverse pulsation of blood flow back toward the person's upper torso and head immediately following systole. This results in pressure spikes of as much as 50 mmHg being imposed upon any partial arterial blockages that may be present in those portions of the person's body, and may in fact enable formation of collateral circulation passages around such partial blockages. In order to be effective, EECP is typically administered to a person over a series of 35 one-hour treatments during a seven-week period. During their abrupt inflation the pressure cuffs can often inflict significant discomfort in the person however, thereby causing him or her to be distressed and perhaps counteracting the therapeutic effect for which the device was intended. Furthermore, there has apparently been no suggestion that EECP is helpful in promoting enhancement of intraocular, lymph and neural fluid flows within a person's eyes.

Another device was described in a book entitled “Surgical Nursing” by Eliason, Ferguson and Farrand and published as early as 1929 by the J.B. Lippincott Company. It was called a “Sander's oscillating bed for treatment of peripheral vascular disease”. In describing the Sander's oscillating bed and its use the authors stated the following:

“The Sander's oscillating bed is a method of administering passive exercises to allow intermittent filling and emptying of capillaries, venules and arterioles. The bed is set upon a rocker operated by a motor so that it tilts on its long axis at regular intervals. The intervals may be adjusted according to the needs of the patient and the wishes of the physician. This method of administering passive postural exercises may be carried out day and night and is claimed by some to have produced relief of the rest pain and of the pain associated with ulcers and gangrene. It may be used not only in arteriosclerosis and thrombo-angitis obliterans but also in minor degrees of arterial embolism.”

The Sander's oscillating bed was also described in the Aug. 4, 1951 issue of the Journal of the American Medical Association as being utilized at “high frequency” as a “vasoscillator”—thus implying that it was useful for dilating clogged blood vessels. It is believed herein that when it was utilized for this purpose, the Sander's oscillating bed was driven at a relatively high frequency significantly beyond 20 cycles/minute. On the other hand, other articles published during the 1950s detailed its use for augmenting ventilation in patients with poliomyelitis. This was obtained via internal manipulation of the patient's lungs obtained as a result of alternating gravitational forces cyclically displacing his or her intestines such as to cyclically elevate and depress the patient's diaphragm. In this case, the Sander's oscillating bed was driven at a “relatively low frequency” of perhaps 20 cycles/minute that was considered to be compatible with a normal rate of breathing.

As will be fully explained hereinbelow, it is believed herein that operation of such a bed at the high frequencies noted above would be grossly inappropriate. First of all, it would most likely induce discomfort in the patient. More significantly, there would most likely be insufficient time to substantially drain pooled venous blood from selected portions of a person's venous system during the portion of each cycle when they are subject to pressure values lower than atmospheric pressure, or later during the cycle, to totally fill the veins comprised in those portions of the person's venous system with new venous blood coming from associated arterioles, capillaries and venules—when otherwise those veins would have dilated and become subject to pressure values greater than atmospheric pressure. Thus, implementation of even the basic concept of blood pressure modulation as explained below would not be possible on a Sander's oscillating bed operated the high frequencies noted above. But as is also explained below and in some cases of perhaps even more significance, such high frequency operation would likely be incompatible with enhancing operation of a person's lymph system.

Further, it is also believed herein that all versions of the Sander's oscillating bed were implemented with a flat (e.g., planar) bed and, as implied above, “set upon a rocker operated by a motor so that it tilts on its long axis at regular intervals”. Because of such construction, it is also believed herein that shoulder and/or foot constraints were typically utilized for longitudinally restraining patients so that they wouldn't slide “up or down” excessively. It is believed herein that use of such artificial shoulder and foot constraints would also tend to induce discomfort in the patient. Perhaps because of the requirement for such artificial constraints, or because of the above explained high frequency misapplication in its use, or even simple patient discomfort associated with the high frequency operation, or because of safety concerns relating to the open rocker construction, the Sander's oscillating bed obviously fell out of favor.

An alternate type of therapeutic device that includes a bench or support member upon which a person can lie down is described in detail in U.S. Pat. No. 6,261,250. Harnesses are attached to each arm and leg of the person. The harnesses are attached to cables actuated by a gearmotor in a manner that cyclically and synchronously raises and lowers all of the person's limbs. The change in elevation of the person's limbs causes a moderate modulation of blood pressure in both of the arterial and venous networks of the person's cardiovascular system. Although it runs at a cyclic rate of slightly over 20 times/minute, this therapeutic device is none-the-less believed to be somewhat effective in enhancing blood flow throughout the person's circulatory system, including his or her coronary system as well as in his or her brain and eyes. However, it does require an amount of coordinated muscle activity on the person's part to properly position him- or her-self on the bench and [to] maintain his or her limbs within the harnesses, as well as to properly interact with the device. For some people, such interactions can be stressful and could even somewhat counteract the therapeutic effect for which the device is intended. Furthermore, the therapeutic device depicted in the '250 patent comprises an open counter-balanced flywheel that for safety reasons would obviously be of concern.

It is important to understand that utilization of any of these example therapeutic devices does not impose a medically oriented treatment upon a person similarly to that such as he or she would typically experience via utilizing invasive types of treatment provided by a medically licensed physician through his or her prescription of medication, or by execution of a surgical procedure. Rather, their use is generally non-invasive in nature, and with the exception of EECP, any person could use them in a self-operated manner at his or her own volition. Alternately of course, such self-operated apparatus could also be utilized with the assistance of an alternative medicine practitioner, or even at the suggestion of a medically licensed physician. Their use by any person can most accurately be described as that of non-invasively conditioning that person in a manner essentially similar to him or her exercising on exercise apparatus in a gym, so that his or her body could be enabled for improving, or even for possibly curing, itself.

It is believed herein that the human body is capable of achieving amazing self-curative powers. Thus it is also believed herein that an improved therapeutic device and an improved method are needed for enhancing blood circulation as well as intraocular, lymph and neural fluid flows within a person's eyes with the aim of relieving symptoms of macular edema, macular degeneration, glaucoma, diabetic retinopathy, and retinal artery and vein occlusions.

### SUMMARY OF THE INVENTION

The present invention relates to an improved therapeutic method and self-operated apparatus intended for enhancing blood circulation as well as intraocular, lymph and neural fluid flows within a person's eyes. The person places him or herself in a supine position on a support member, such as a bed or table formed in a contoured manner whereupon a person can comfortably lie without artificial constraints. The support member is then cyclically rocked or tilted in a seesaw manner so that the person is tilted from a head-elevated position to a lower extremities-elevated position. This results in a modulation of arterial and venous blood pressures within the person's eyes, and in turn as will be explained below, a modulation of intraocular pressure and an associated improvement in intraocular, lymph and neural fluid flows. Generally, it is either believed or has been anecdotally observed that symptoms of macular edema, macular degeneration, glaucoma, diabetic retinopathy, and retinal artery and vein occlusions.

A drive mechanism is used to cyclically move the support member in a seesaw manner in order to elevate the person's head above his or her lower extremities, and then to elevate the person's lower extremities above his or her head. When utilized generally to relieve the symptoms of macular edema, macular degeneration, glaucoma, diabetic retinopathy, and retinal artery and vein occlusions, the cyclical rate of motion can range between 2 to 10 cycles/minute and is preferably about 6 cycles/minute. Additionally as explained below, it may be desirable for some individuals having the symptoms of glaucoma to sleep on the self-operated apparatus wherein it may be desirable to selectively terminate the cyclical motion. In any case, the total angular range of motion of the support member relative to its nominally centered horizontal position can range between 10° and 60° and is preferably around 30°.

Again, it should be emphasized that utilization of the therapeutic method and self-operated apparatus does not impose a medically oriented treatment upon a person similarly to that such as he or she would typically experience via utilizing invasive types of treatment provided by a medically licensed physician through his or her prescription of medication, or by executing a surgical procedure. Rather, its use is generally non-invasive in nature and can be used by any person at his or her own volition. Alternately of course, it can be utilized with the assistance of an alternative medicine practitioner, or even at the suggestion of a medically licensed physician. In fact, its use by any person can more accurately be described as that of non-invasively conditioning that person via an internal massaging of his or her tissues and various fluid flow channels, so that his or her body can be enabled for improving, or even for possibly curing, itself.

Other benefits, features and aspects of the present invention will become apparent from a review of the following description of preferred embodiments, when viewed in accordance with the attached drawings and appended claims.

### BRIEF DESCRIPTION OF THE DRAWINGS

FIG. 1 is a flow chart that illustrates an example method intended for enhancing blood circulation as well as intraocular, lymph and neural fluid flows in a human body and brain in accordance with the present invention.

FIG. 2 is a schematic view of the cardiovascular circulatory system.

FIG. 3 is a schematic view of a greatly enlarged minute portion of a capillary bed.

FIGS. 4A, 4B and 4C are side views illustrating the range of motion of an example therapeutic device utilized for practicing the example method of FIG. 1.

FIG. 5 is a schematic view of a lymph collector.

FIGS. 6A and 6B are schematic views of a lymph pre-collector.

FIG. 7 is a sectional view of a human eye.

FIG. 8 is a side view depicting the example therapeutic device shown in FIGS. 4A, 4B and 4C in greater detail.

FIG. 9 is a flow chart that illustrates a method of controlling a therapeutic device comprising a servo drive mechanism but otherwise similar in function to that shown in FIG. 8.

FIG. 10 is a perspective view of an example drive mechanism for cyclically moving the therapeutic device shown in FIG. 8.

FIG. 11 is a schematic view of a control circuit for selectively stopping the therapeutic device shown in FIG. 8.

FIG. 12 is a perspective view of a cam activated switch utilized within the control circuit of FIG. 11.

### DETAILED DESCRIPTION OF THE PREFERRED EMBODIMENTS

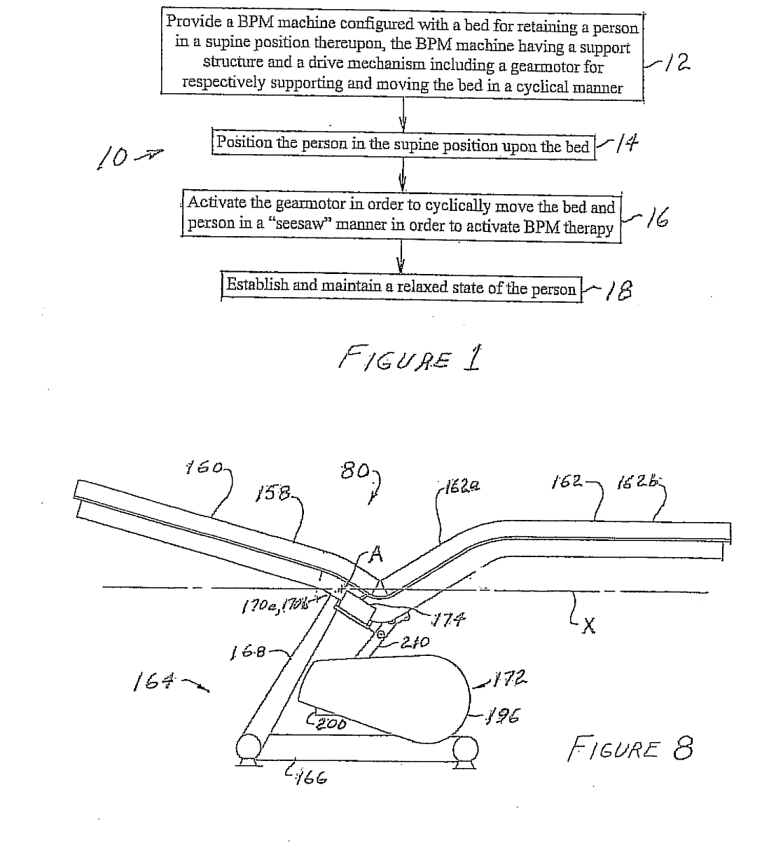

FIG. 1 is a flow chart that illustrates an improved example BPM therapy method 10 for inducing blood pressure modulation therapy (hereinafter “BPM therapy”) on a blood pressure modulation machine (hereinafter “BPM machine”), which BPM therapy is believed herein to enable enhancement of blood circulation as well as intraocular, lymph and neural flows in the eyes as well as through the human circulatory, lymph and nervous systems in general. In some examples, the BPM therapy method 10 is either believed herein or has in fact been anecdotally observed to be therapeutically helpful for enhancing blood circulation as well as intraocular, lymph and neural fluid flows within a person's eyes with the aim of relieving symptoms of macular edema, macular degeneration, glaucoma, diabetic retinopathy, and retinal artery and vein occlusions.

A first step 12 of the example BPM therapy method 10 includes providing a BPM machine, which BPM machine comprises a generally horizontal and preferably contoured support member (hereinafter referred to as a “bed”) configured for retaining a person generally in a supine position thereupon along a longitudinal axis such that his or her head are longitudinally spaced apart from his or her lower extremities. The BPM machine also comprises necessary support structure as well as a gearmotor and drive mechanism for pivotally supporting and moving the bed in a cyclical manner to be described in detail hereinbelow. A second step 14 includes positioning the person on the bed so that he or she lies supinely thereupon with his or her head, and lower extremities spaced apart generally along the longitudinal axis.

A third step 16 includes activating the gearmotor for the purpose of cyclically moving or tilting the bed, and of course the person, in a “seesaw” manner in order to activate BPM therapy. This causes the person's head to be elevated above his or her lower extremities, and then the person's lower extremities to be elevated above his or her head, and vice-versa. In one example, the cyclical rate of alternate elevation of the person's head, and lower extremities (hereinafter “cyclical rate”) can range between 2 and 10 cycles/minute and is preferably about 6 cycles/minute while the total angular range of motion (hereinafter “angular range”) of the support member relative to its nominally centered horizontal position can range between 10° and 60° and is preferably around 30°.

As described in detail below, this procedure modulates blood pressure in both of the arterial and venous networks of the cardiovascular system. It is believed herein that even more dramatic switching of venous blood pressure between positive and negative values and back again with respect to atmospheric pressure (hereinafter “venous blood pressure switching events”) during each cycle of venous blood pressure modulation is a significant factor in enhancing blood circulation as well as intraocular, lymph and neural fluid flows within the eyes. This is believed herein to account for the above-mentioned herein believed or in fact anecdotally observed improved quality of life for persons having certain eye related problems such as macular edema, macular degeneration, glaucoma, diabetic retinopathy, and retinal artery and vein occlusions.

Utilizing lesser angular ranges than the preferred 30° would of course result in a reduced modulation of arterial and venous blood pressure. Although it is believed herein that this would also be effective in enhancing blood circulation as well as intraocular, lymph and neural fluid flows within the eyes, it might result in extended treatment times and/or an extended series of treatments.

On the other hand, utilizing greater angular ranges than the preferred 30° would result in increased modulation of blood pressure. But this might require the person to be strapped or “velcroed” to the bed in order to preclude him or her from sliding either upwards or downwards, and would almost certainly be required in cases wherein a selected angular range of motion resulted in the person's torso assuming even a relatively modest negative angular attitude whenever the bed approached its extreme lower extremities-elevated position. Furthermore, greater angular ranges might require the cyclical rate to be reduced in order to maintain a comfortable and relaxed state of the person. This of course would reduce the number of arterial and venous blood pressure modulation and/or switching events, and thus could counterproductively compromise the below described enhancement of the lymph system. In any case, it has been anecdotally observed that the preferred 30° angular range is quite sufficient for achieving desired therapeutic results.

The fourth step 18 of the example BPM therapy method 10 includes establishing and maintaining a comfortable and relaxed state of the person. In a preferred example, such a comfortable and relaxed state corresponds to establishing a sleep state of the person while he or she is experiencing BPM therapy. In another example, the comfortable and relaxed state corresponds to a consistent “at rest” blood pressure state of the person, determined according the person's age, weight, height, or other factors. In yet another example, the comfortable and relaxed state corresponds to the heart rate of the person, such as an “at rest” heart rate determined according the person's age, weight, height, or other factors. Factors involved in establishing and maintaining the comfortable and relaxed state of the person include: locating the BPM machine in a relatively isolated and quite environment; avoiding any contact with the person (i.e., such as talking to him or her) during his or her treatment period with the purpose of inducing him or her to fall into a sleep state; and/or failing that, engaging in quiet and relaxing conversation with the person for the purpose of calming him or her if he or she exhibits hyperactivity, hypersensitivity or hyperirritability symptoms.

Properly selecting angular range and cyclical rate values is also important in establishing and maintaining the comfortable and relaxed state of the person. The combination of angular range and cyclical rate is chosen such as to preclude dizziness or other discomforts in the person and is a definite factor in inducing a comfortable and relaxed state conducive to the person attaining a state of sleep. In general, it has been found through anecdotal observation that the combination of angular range and cyclical rate should be chosen such that their product is between 90 degree-cycles/minute and 270 degree-cycles/minute. Consistently, the preferred combination of an angular range of 30° and a cyclical rate of about 6 cycles/minute results in their product being 180 degree-cycles/minute, which values have been anecdotally observed to provide the above noted improvements in quality of life without inducing discomfort. Other combinations chosen from within the above mentioned angular ranges of 10° and 60°, and cyclical rates between 2 to 10 cycles/minute could certainly be acceptable for therapeutic use however.

Prior to beginning any treatment using the present invention, a preliminary workup comprising noting a person's vital statistics and perhaps performing any pertinent neurological testing could be done in order to establish a baseline status for that person as of the start of that particular treatment session. One might note a person's age, blood pressure, heart or neurological disease history or conduct and record any appropriate blood count, neuropathy or other tests should that person be diabetic for instance. In addition, special precautions should be taken in the case of a brain injured person or perhaps for one having Alzheimer's disease. Further, it would be desirable to do a comparative post treatment workup as well in order to record any changes related to the person having experienced BPM therapy during that session. And still further, it would be desirable to compile each person's workup documentation in order to establish that person's progress over time.

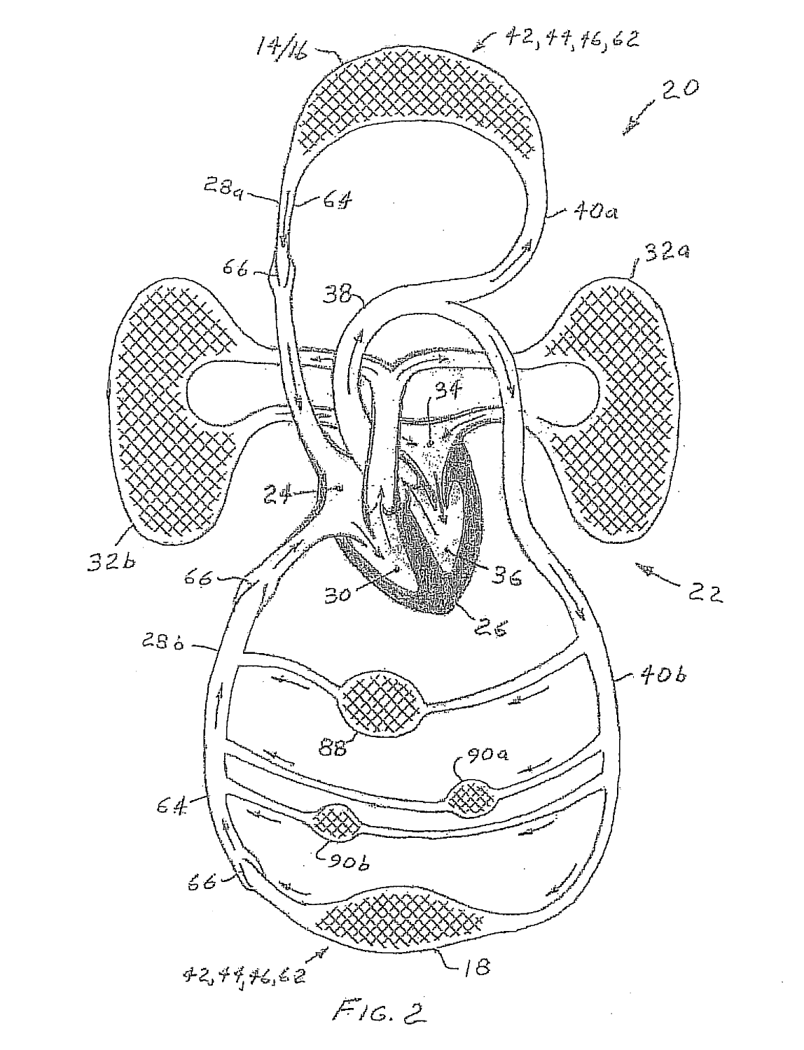

FIG. 2 depicts a human circulatory system 20 in a highly simplified schematic manner. The cardio-pulmonary portion 22 of the human circulatory system 20 includes the right atrium 24 of the heart 26 receiving oxygen-depleted blood from upper and lower body venous networks 28a and 28b (hereinafter “venous system 28a/28b”), pumping it via the right ventricle 30 through left and right lungs 32a and 32b wherein carbon dioxide is exchanged for oxygen, then on to the left atrium 34 and ventricle 36 of the heart 26 from where the now oxygen-rich blood is pumped into the aorta 38, and from there to the upper and lower body arterial networks 40a and 40b (hereinafter “arterial system 40a/40b”). The arterial system 40a/40b comprises an enormous multitude of ever-finer arteries 42 and arterioles 44 that convey the oxygen-rich blood from the heart 26 to a truly extraordinary multitude of perhaps a billion or more capillaries 46 (i.e., with one set thereof being shown in a highly simplified schematic manner in FIG. 3).

Layers of smooth spirally oriented muscle cells (not shown) are comprised in the arteries 42. They serve to maintain finite values of arterial blood pressure between systolic events. Similar but much finer layers of smooth spirally oriented muscle cells (also not shown) are also comprised in the arterioles 44. These finer layers of smooth spirally oriented muscle cells are utilized by a cardiovascular control center (not shown) in the brain for selectively controlling arteriole size and thus blood flow resistance. Further as illustrated in the highly magnified schematic view of FIG. 3, a pre-capillary sphincter 48 protects each capillary 46. The pre-capillary sphincters 48 are utilized by the cardiovascular control center for selectively maintaining instant proportions of the capillaries 46 that are open to blood flow at any particular time in any portion of the body. These factors permit the brain to execute an almost incomprehensibly complex task of regulating blood flow throughout the human circulatory system 20 as well as controlling instant blood pressure values and selectively servicing trauma of any type (i.e., including minor trauma such as a cut or scrape).

Additionally, the brain indirectly controls heart rate via generating neural inputs to sympathetic and parasympathetic nerve fibers (not shown) in the heart 26. Although the complexity of this control system is truly amazing, it has a rather slow response time. One indication of this slowness is the length of time (i.e., in the order of a minute or more) for a minor scrape to be serviced by the arrival of fresh blood that occurs via the opening of a multitude of juxtaposed pre-capillary sphincters 48.

As will be discussed in greater detail below, blood flows through the open ones of the capillaries 46 wherefrom oxygen, sugar and protein bearing plasma flows into surrounding interstitial space 50 through micro-pores 52 located near the moderately pressurized arteriole/sphincter ends 54 of the capillary walls 56. Carbon dioxide and waste bearing plasma then flows back into the capillaries 46 via osmosis generated pressure through other micro-pores 58 located near the downstream or venule ends 60 of the capillary walls 56. Finally, the then oxygen depleted blood flows through venules 62 and into the venous system 28a/28b, which venous system 28a/28b acts as a reservoir containing about 65% of the body's total blood volume.

As shown schematically in FIG. 2, the larger veins 64 of the venous system 28a/28b comprise sequentially spaced semi-lunar folds that function as one-way check valves 66. The check valves 66 serve to preclude reverse flow back toward the venules 62 and capillaries 46. Generally the veins 64 and venules 62 of the venous system 28a/28b are simpler and more compliant than the arteries 42 and arterioles 44 of the arterial system 40a/40b. However, they also include layers of smooth spirally oriented muscle cells that (e.g., at least in the larger ones of the veins 64) are utilized by the cardiovascular control center for regulating their circumferential size. This involves the brain and body continuously executing a very complex and precise servo control of the volumetric size of the venous system 28a/28b as a whole, which servo control function also has a fairly long implementation time constant.

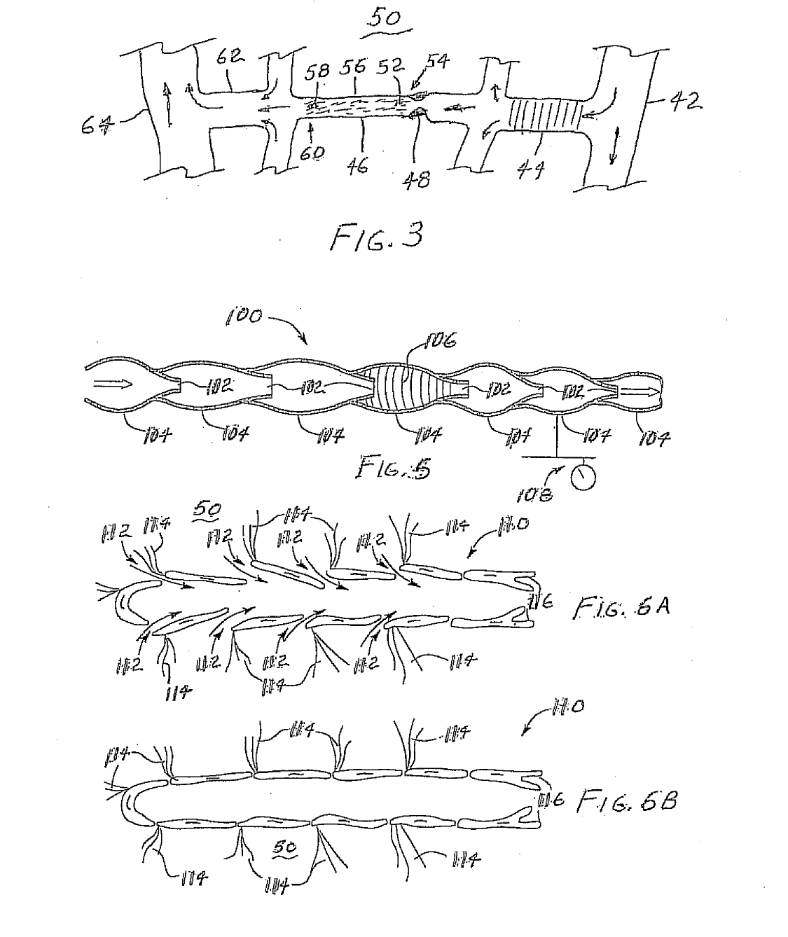

The volumetric size of the venous system 28a/28b is controlled such that average venous blood pressure at the entrance to right atrium 24 of the heart 26 is maintained at a level just slightly above atmospheric pressure in response to signals emanating from a cardiopulmonary mechanoreceptor 68 located in the right atrium 24 of the heart 26. This results in average venous blood pressure being maintained at a zero value relative to atmospheric pressure at a horizontal plane 70 (e.g., described below and depicted in FIGS. 4A, 4B and 4C) located a few inches thereabove (hereinafter the “zero venous pressure plane 70”).

As a result, venous blood pressure present at any particular point within a person's venous system 28a/28b can be determined by the formula

P=1.875h

where P is the difference between venous blood pressure at that particular point and atmospheric pressure (in mmHg), and h is the vertical distance between that particular point and the vertical position of his or her zero venous pressure plane 70 (in inches). Thus, portions of the venous system 28a/28b that are instantly positioned vertically below the zero venous pressure plane 70 have positive pressure (e.g., relative to atmospheric or zero pressure) whereby there is a positive differential pressure value imposed between them and the outside of the person's body. On the other hand, portions of the venous system 28a/28b that are instantly positioned vertically above the zero venous pressure plane 70 have negative pressure whereby there is a negative differential pressure value imposed between those portions of the venous system 28a/28b and the outside of the person's body. This compresses those veins and causes previously “pooled” venous blood contained therein to freely move through the above described check valves 66 and “drain” back toward the person's vena cavas (i.e., the veins that convey the venous blood into right atrium of the heart) with the result that those veins are compressed or even somewhat flattened out.

Then later in the cyclic motion, when those portions of the venous system 28a/28b are again positioned below the zero venous pressure plane 70, they fill with oxygen depleted blood flowing from juxtaposed capillaries 46 and venules 62 (e.g., not back down through the larger veins 64 themselves because of the one-way flow nature of the valves 66) and expand. In either of these cases, it is believed herein that it is necessary to provide adequate time for allowing these “draining and filling” functions to substantially occur. Thus the relatively slow preferred cyclic rate of operation of about 6 cycles/minute is herein deemed to be appropriate for this reason alone.

This general principle can be demonstrated by observing what happens to a visible peripheral vein running along the back of one's hand and arm as that hand and arm are slowly raised toward shoulder height. Portions of that vein will soften and contract, and even begin to flatten out as they reach a few inches below shoulder height and then remain flattened while they are above that height. In fact, as one slowly raises the hand and arm he or she may even feel the progression of this flattening as different portions of the vein suffer a transition from positive to negative pressure. It is believed herein that substantially the same action occurs within the fine venous structures comprised in the upper torso 72 and head 82, the lower extremities 86, and most particularly, the eyes 84 of a person whenever he or she is supinely disposed upon a cyclically moving BPM machine. And as is explained below, it is further believed that this cyclically varying venous pressure is a significant factor in causing a concomitant modulation of interstitial fluid pressure and volume as well.

Such variations of venous blood pressure are illustrated in FIGS. 4A, 4B and 4C for a person 78 disposed on an example BPM machine 20. FIG. 4A depicts the portion of its cycle of operation whereat the person 78's head 82 and eyes 84 are elevated; FIG. 4B depicts the portions of the cycle whereat the person 78 is disposed in a nominally centered horizontal position (hereinafter “horizontal position”); and FIG. 4C depicts the portion of the cycle whereat the person 78's lower extremities 86 are elevated. Of these, the horizontal position depicted in FIG. 4B can logically be said to approximate the average disposition of the person 78 when he or she is disposed upon the cyclically moving BPM machine 80. Thus in the horizontal position, the instantaneous location of the zero venous pressure line 32 can be approximated by a zero venous pressure plane 70b passing through the upper torso 72 whereby portions of the venous system 28a/28b above and below the zero venous pressure plane 70b are respectively subject to negative and positive pressure values. Zero venous pressure planes 70a and 70c respectively depicted in FIGS. 4A and 4C similarly define instantaneous locations of the zero venous pressure line 32. Thus the person 78's head 82 and eyes 84 are subject to alternating negative and then positive pressure values, even as his or her lower extremities 86 are concomitantly subject to alternating positive and then negative pressure values.

Assuming that a combination comprising the preferred angular range and cyclical rate values of about 30° and 6 cycles/minute is chosen, gravitational forces resulting from alternating cyclical elevation of the person 78's head 82 and eyes 84, and then lower extremities 86 rhythmically modulate the venous blood pressure in the head 82 and eyes 84, and also of course the lower extremities 86, over a range of perhaps 20-30 mmHg. Thus, when the head 82 and eyes 84, and alternately the lower extremities 86, attain peak elevation above the zero venous pressure plane 70 as respectively depicted in FIGS. 4A and 4C, venous blood pressure in those portions of the person 78's body is lowered below atmospheric pressure by up to 15 mmHg. Thus, there is pressure differential of as much as 15 mmHg between atmospheric pressure externally impressed upon the person 78's body and the venous blood pressure within those portions of the his or her body. This pressure imbalance enables the surrounding tissue to somewhat compress or shrink those portions of the venous system 28a/28b and forces venous blood to flow from those veins generally toward the vena cavas (again, this phenomenon is responsible for the observed flattening of peripheral veins in a person 78's hand and forearm as he or she raises that arm as well as the general feeling that blood is “draining” down from that arm as and after it is elevated).

On the other hand, as the head 82 and eyes 84, or alternately, the lower extremities 86 are lowered as respectively depicted in FIGS. 4C and 4A, arterial pressure values in those portions of the person 78's body rise in the head 82 and eyes 84 by perhaps up to 10 mmHg and alternately in the lower extremities 86 by perhaps up to 20 mmHg above the instantaneous values present at the zero venous pressure plane 32. There are corresponding increases in venous blood pressure values of course, but such increases somewhat lag behind because those veins must first “fill up” with new venous blood issuing from their associated artery and arteriole fed capillaries 46 and venules 62.

As described in a book entitled “Exercise Physiology” by William D. McArdle, Frank I. Katch and Victor L. Katch and published by Williams & Wilkins of Baltimore, Md. and Media, Pa. (and again with reference to FIG. 2 herein) arterial pressure decreases by about 20% of the average value it had in the aorta 38 by the time the arterial blood reaches the arterioles 44 and further decreases by perhaps another 35% as it passes through the arterioles 44. Thus ignoring the gravity effects described elsewhere herein, blood pressure entering the arteriole/sphincter ends 54 of the capillaries 46 has an average value of about 45% of the average arterial pressure present in juxtaposed portions of the arterial system 40a/40b. Then also ignoring the above described transient effect relating to the delayed filling of the veins 64, the pressure decreases by about another 25% as the blood passes in parallel through the capillaries 46 and as plasma through the serial combination of the micro-pores 52, interstitial space 50 and micro-pores 58). The transient effects could amount to as much as another 10% pressure drop or perhaps as much as a transient 40% increase in driving pressure through the capillaries 46 and the serial combination of the micro-pores 52, interstitial space 50 and micro-pores 58. In addition, the driving pressure through the serial combination of the micro-pores 52, interstitial space 50 and micro-pores 58 is further assisted by osmotically generated supplemental pressure present at least at the micro-pores 58.

In general and especially in view of the compliant nature of the surrounding tissue itself, all of these factors result in a rather complex modulation of interstitial fluid volume and pressure as a function of the cyclic motion of the BPM machine 80. Generally the interstitial space 50 will vary between having a slightly swollen, pressurized condition when a portion of a person 78's anatomy is lowered and a somewhat shrunken non-pressurized condition when it is elevated. The point of all of this is that interstitial space volume and pressure will vary cyclically in a rather erratic yet synchronized (e.g., with the motion of the BPM machine 80) manner at a frequency of about 6 cycles/minute. Further, it is also apparent that the pressure drop across the various comprised flow channels and orifices varies in a similarly erratic yet synchronized manner as well. It is believed that these actions result in a general massaging of the tissue and a general tendency to break up any blockages present in the flow channels and orifices.

Again, pressure present within the arteriole/sphincter ends 54 of the capillaries 46 is sufficient to drive plasma comprising oxygen, sugars, protein, fat and doubtless other material into the surrounding interstitial space 50 through the first encountered micro-pores 52 as entering interstitial fluid that enables oxygen and nutrient to be delivered to the tissue. Then generally, the interstitial fluid “morphs” via the oxygen/carbon dioxide exchange as well as through most of the other materials being replaced by waste products. As noted above, fluid pressure values at the venule ends 60 of the capillaries 46 are normally low enough to allow osmotic pressure to drive most of the interstitial fluid back into those capillaries 46 via the micro-pores 58.

On the other hand, as the head 82 and eyes 84, or alternately, the lower extremities 86 are lowered as respectively depicted in FIGS. 4C and 4A, pressure values in the venous blood in those portions of the person 78's body rise from a negatively valued pressure to a positively valued pressure of perhaps up to 10 mmHg in the head and eyes, and 20 mmHg in the lower extremities as they “fill up” with new venous blood issuing from their associated artery and arteriole fed capillaries 46 and venules 62. Thus, positive differential pressure differences occur between localized venous blood pressures and atmospheric pressure. This causes the veins to swell because the returning blood from arterioles 44, capillaries 46 and venules 62 tends to “pool” under the influence of ever-higher pressure and expands the smooth spirally oriented muscle tissue of the veins. And concomitantly of course, the arterial blood pressure undergoes similar modulation.

But in addition to the arterial and venous blood pressures cyclically varying in the manner described above, arteriole and venule pressures are modulated in a cyclically varying manner as well. This of course results in a cyclic modulation of the pressure values imposed upon the tiny pores in both the arteriole/sphincter and venule ends 54 and 60 of the capillary walls 56. This in turn results in a concomitant in phase modulation in interstitial fluid pressure and volume. And that in turn results in compression and stretching of juxtaposed arterial, lymph or neural orifices and flow channels. Should any such orifices and flow channels be dysfunctional in any way (i.e., such as by being blocked), it is believed herein that they may be so restored to a more natural and functional state.

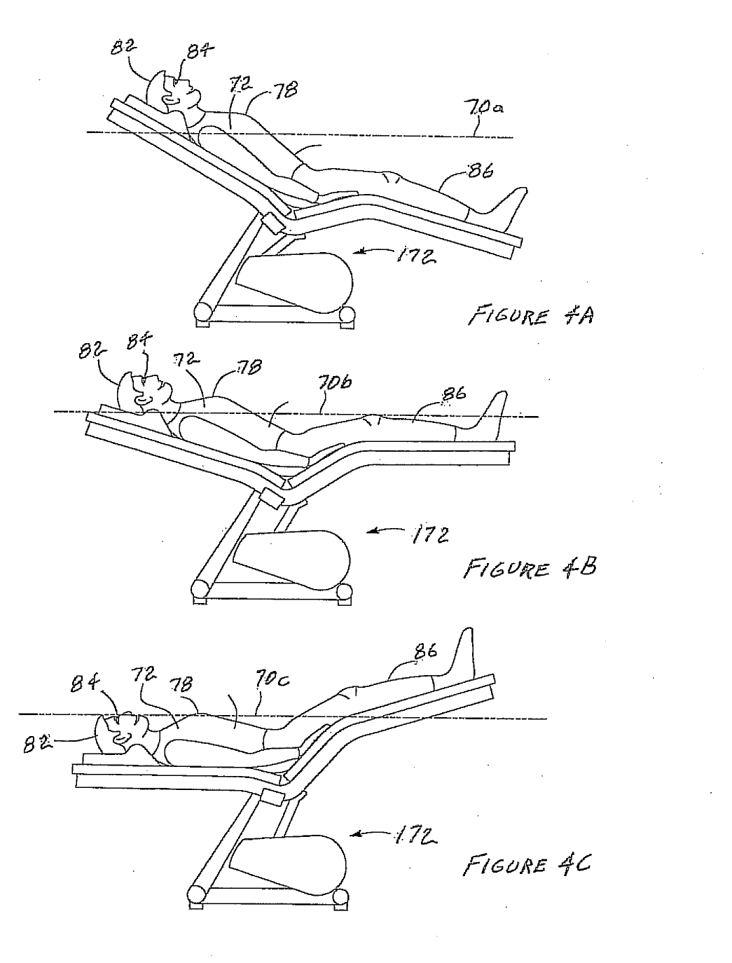

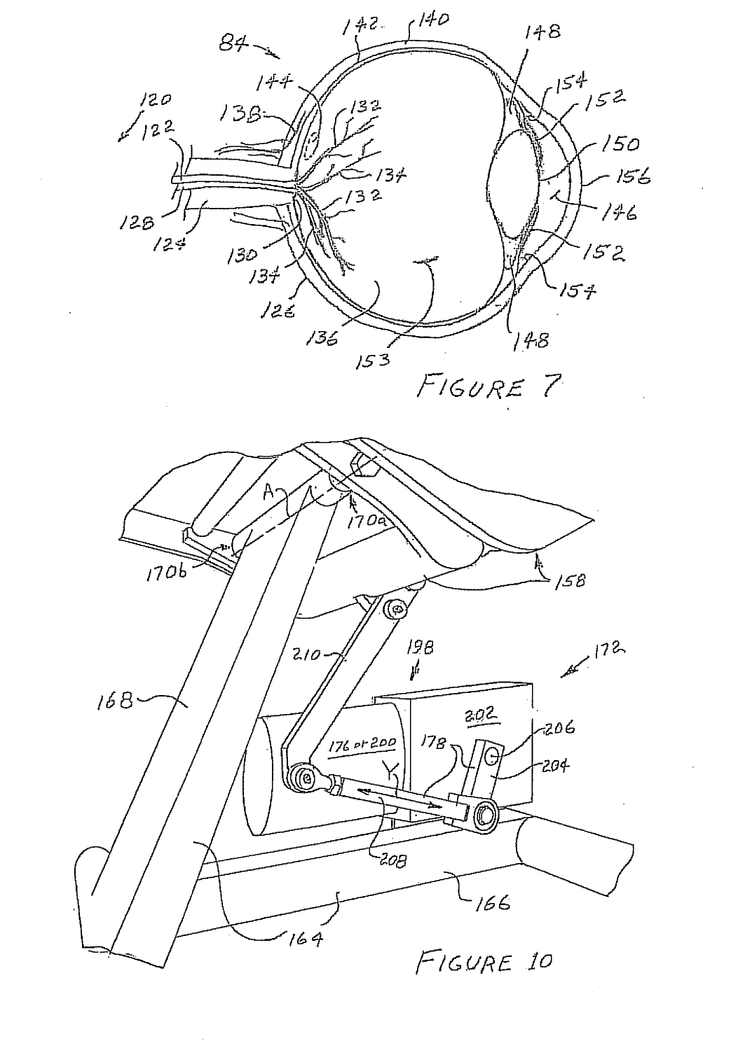

As noted above, osmotic pressure drives plasma comprising carbon dioxide and most of the other interstitial fluid bearing waste components back through the tiny pores comprised in the venule ends 60 of the capillaries 46. However, the remaining excess interstitial fluid (i.e., excess protein, fat and other waste material) is normally removed by a person 78's lymph system, portions of which are schematically depicted herein in FIGS. 5, 6A and 6B.

As described in detail in a book entitled “Silent Waves, Theory and Practice of Lymph Drainage Therapy” by Bruno Chickly, M.D., D.O. (hon) and published by International Health & Healing Inc. Publishing of Scottsdale, Ariz., the lymph system is a secondary circulatory system that normally implements a one-way flow of the excess protein, fat and other waste bearing material (i.e., as lymph fluid) from interstitial space 50 (e.g., from everywhere in the body) generally upwards through various lymph flow channels (i.e., as described in more detail below) toward a person 78's right lymphatic and thoracic ducts (not shown). These ducts then drain the lymph fluid into the circulatory system at the right and left subclavian veins, and then sequentially from the vena cava through the right side 24/30 of the heart 26, the lungs 32a/32b, the left side 34/36 of the heart 26, and finally, to the liver 88 and or kidneys 90a/90b for processing and proper elimination.

As depicted schematically in FIG. 5, one-way flows of lymph fluids within the lymph system generally pass through a multitude of lymph collectors 100 each comprising closely spaced sequential one-way valves 102 (i.e., similar to those found in veins) interconnected by very short segments of lymphatic vessels 104 called lymphangions. The lymphangions 104 are only about 6 to 20 mm long (i.e., as described in “The Genetic History of the Valves in the Lymphatic System of Man”, by O. F. Kampmeir, Am. J. Anat. 1928, 40:413-457). They comprise spiral muscle layers 106 that contract involuntarily in response to innervation signals issuing from the person 78's autonomic nervous system as indicated schematically at numeric indicator 108. When a person 78 is at rest, the rate of such contractions normally occurs at only about 5 to 8 cycles/minute (i.e., as described in “Intrinsic Contractility of Leg Lymphatics in Man: Preliminary Communication”, by W. L. Olszewski et. al., Lymphol, 1979, 12: 81-84: and “Intrinsic Contractility of Prenodal Lymph Vessels and Lymph Flow in Human Leg” by W. L. Olszewski et. al., Am. J. Physiol, 1980, 239:775-783). In so doing, the combinations of sequential one-way valves 102, lymphangions 104, and spiral muscle layers 106 act as pumping mechanisms that serve to force the lymph fluid along through the one-way valves 102 and on to the right lymphatic and thoracic ducts—thus moving the one-way flow of excess protein, fat and other waste bearing lymph fluid upwards through the person 78's lymphatic flow channels and eventually on to the right and left subclavian veins as described above.

As depicted schematically in FIGS. 6A and 6B, excess interstitial fluid first becomes lymph fluid by entering minute lymph capillaries (not shown) formed like cul-de-sacs and located in extra cellular spaces surrounding each one of an enormous multitude of lymph pre-collectors 110. As shown in FIG. 6A, the lymph fluid next enters the lymph pre-collectors 110 through open junction ends 112 whenever the fluid pressure in the lymph pre-collectors 110 is less than that present in the minute lymph capillaries, and of course, juxtaposed interstitial space 50. Anchoring filaments 114 help to open the junction ends 112 widely whenever that differential fluid pressure becomes significant. On the other hand, whenever that differential fluid pressure inverts, the junction ends 112 immediately close, as shown in FIG. 6B, in order to prevent back flow of lymph fluid into the minute lymph capillaries. The lymph fluid next enters juxtaposed lymphangions 104 (not shown in FIGS. 6A and 6B) via lymphatic bicuspid valves 116. On the other hand, the lymphatic bicuspid valves 116 are closed by inverse differential fluid pressure whenever higher pressure is present in the juxtaposed lymphangions 104 (i.e., should such occur during the period when the lymphangions 104 are contracting) in order to preclude lymph fluid back flow into the lymph pre-collectors 110.

Should any veins be subject to increased pressure values (i.e., such those in one's feet while on a long airplane trip) the normal osmotic flow of interstitial fluid back into juxtaposed capillaries 46 will of course be somewhat impeded. This will tend to increase interstitial space pressure that in turn, will attempt to promote increased lymph fluid flow into the minute lymph capillaries and lymph pre-collectors 110. However, because of a concomitant increase of lymph system backpressure that is also due to gravity effects, the normal upward one-way flow of lymph fluid will also be impeded. As a result, lymph fluid will in tend to back up resulting in an increase of interstitial fluid trapped in the interstitial space 50. This phenomena coupled with some swelling of the veins themselves is responsible for the feet swelling during prolonged airplane trips.

Generally, lymph fluid movement occurs slowly and sometimes problematically at rates of up to only about 4 liters/day with nominal driving pressures of only 1 to 2 mmHg provided by smooth spirally oriented muscle cells of each lymphangion. Blockages can, and do, occur—often as a result of trauma or surgery. Such blockages can cause abnormally high intralymphatic pressures and excessively dilated lymphangions 104, which in turn result in juxtaposed ones of the one-way valves 102 becoming incompetent. This allows lymph fluid to flow backwards, and in turn, causes more peripheral lymphangions 104 to excessively dilate with more one-way valves 102 then becoming incompetent. This incompetency is then transmitted back to the lymphatic bicuspid valves 116 and then the junction ends 112, with lymph fluid then flowing back into the interstitial space 50, thus resulting in lymph fluid accumulation in interstitial space 50. The end result is lymphedema with abnormal tissue swelling. Diabetic individuals are especially subject to having such blockages in their lymphatic systems and often suffer from lymphedema with abnormal tissue swelling.

With reference to utilization of BPM therapy on a BPM machine 80, it is interesting to note that its preferred operational frequency of about 6 cycles/minute falls within the above noted typical resting lymphangion spiral muscle contraction rate of 5 to 8 cycles/minute. It is hypothesized herein that the calming action of BPM therapy typically causes a person 78's parasympathetic nervous system to become dominant over his or her sympathetic nervous system and slow his or her lymphangion spiral muscle contraction rate, and further, that this may be a contributing factor in inducing that person 78 to fall into a state of sleep on the BPM machine 80. Especially in conjunction with that, it is further believed herein that after perhaps a few minutes of being on the BPM machine 80, a person 78's lymphangion spiral muscle contraction rate slows to a synchronously matching (e.g., with the BPM machine 80) contraction rate of approximately 6 cycles/minute and “locks” thereto in an appropriately phase locked manner.

As a result, it is hypothesized that when the lower extremities are lowered and interstitial space 50 therein is subject to positive pressure, entry of interstitial fluid into the minute lymph capillaries, lymph pre-collectors 110 and juxtaposed lymphangions 104 is maximized—thereby increasing incoming lymph flow. Then later during the machine cycle when the lower extremities are elevated, a more efficient upward one-way flow of lymph fluid occurs through the lymphangions 104 because the force of gravity then assists lymphangion spiral muscle layer contraction in driving the lymph fluid upward from the lower extremities 86 and downward from the head 82.

As described in detail in a book entitled “Atlas of Ocular Blood Flow” by Alon Harris, Msc, PhD, Christian P. Honescu-Cuypers, MD, PhD, Larry Kagemann, MS, BME, Thomas A. Ciulla, MD and Gunter K. Krieglstein, MD, Phd, and published by Butterworth Heinemann of Philadelphia, Pa., a human eye 84 is normally one of the best-perfused organs in the body. Blood is primarily supplied to the eye 84 from the ophthalmic artery 118. A central retinal artery 120 branches off the ophthalmic artery 118 to penetrate the optic nerve 122 about 10 to 15 mm behind the globe 124. The central retinal artery 120 courses adjacent to a central retinal vein 126 within the central portion of the optic nerve 122. The central retinal artery 120 and central retinal vein 126 emerge from the center of the optic nerve head 128 and branch into four sets of nominally juxtaposed main arterial and venous vessels 130 and 132. The main arterial vessels 130 supply blood to the inner portion of the optic nerve head 128 and the inner two-thirds of the retina 134 in the following manner:

The arterial vessels 130 divide into finer and finer arterial vessels that convey arterial blood through very fine capillaries from which blood plasma separates and conveys oxygen and nutrients to the retinal tissue cells. The plasma retrieves carbon dioxide and other waste materials from the retinal tissue cells and then renters the capillaries whereby the blood therein becomes venous blood that in turn is collected by fine branches of the venous vessels 132 and ultimately returned to the venous system via the central retinal vein 126. Although retinal blood flow accounts for only about 15% of total ocular blood circulation, it is critical because it nourishes highly metabolically active retinal tissue.

Retinal blood flow provided via the main arterial vessels 130 is not controlled by the autonomic nervous system. It normally remains relatively constant over a substantial range of intraocular pressure and systemic blood pressure because the main arterial vessels 130 normally have the ability of auto regulating blood flow in order to maintain nominally constant oxygen delivery to the retina 134. Although retinal blood flow accounts for only about 15% of total ocular blood circulation, it is of critical of course because it nourishes highly metabolically active retinal tissue.

The remainder of the eye 84 is supplied via posterior ciliary arteries 136 that also branch from the ophthalmic artery 118 but in this case do not penetrate the optic nerve 122. Instead, they independently attach to the globe 124 and pierce the sclera 138 to nourish choroidal tissue 140 located behind the retina as well as the anterior one-third portion of the retina 134.

Resistance to choroidal blood flow is generally controlled by the autonomic nervous system. The choroidal blood flow system is a high-flow, variable-rate system accounting for about 85% of total ocular blood circulation. Autonomic nervous system control of the choroidal blood flow system does not extend to those portions of the retina 134 however, because they auto regulate instead. Thus, blood flow and nourishment of the whole retina 134 normally remains relatively constant over a substantial range of intraocular pressure and systemic blood pressure.

Macular degeneration is the leading cause of blindness. Traditionally, it has been believed that senescence (or just plain aging) of retinal pigment epithelium (i.e., tissue that metabolically supports and maintains photoreceptors just behind the macula 142, or central portion of the retina 134) leads to age-related macular degeneration. It has been thought that the senescent retinal pigment epithelium accumulates metabolic debris and that progressive engorgement thereof leads to the formation of drusen (crystalline particles) and further dysfunction of remaining retinal pigment epithelium.

More recently, it has been proposed that perfusion defects within the choroidal tissue elements 140 may be a cause of the above-described senescence of the retinal pigment epithelium. Choroidal blood flow is difficult to quantify because overlying retinal circulation and the multilayered nature of the choroidal circulation complicates analysis. However, a number of researchers have published data indicating that age-related macular degeneration is often accompanied by abnormal perfusion within the choroidal tissue elements 140.

Macular edema occurs when fluid and protein deposits collect on or under the macula 142, causing it to thicken and swell. The swelling may distort a person's central vision. This is an indication that the lymph system is failing to remove waste products

Various forms of retinal artery and vein occlusions have also been reported. Either branch or central retinal artery occlusions have been shown to result in ischemic opaqueness of portions of the retina 134. On the other hand, branch and central retinal vein occlusions have been shown to result in diffuse arterial retinal hemorrhages as well as dilated and tortuous retinal veins, plus swelling of the optic nerve head 128.

Retinal blood flow can be significantly altered in diabetic individuals. Generally, retinal blood flow decreases. On the other hand, bulk retinal blood flow typically increases as the disease progresses, presumably arising from thickening of the capillary basement membrane. In addition, retinal arteries of diabetic patients progressively loose their ability to vasoconstrict in response to increased blood oxygen levels because they lack normal auto regulatory responsiveness. Further, diabetes patients are faced with functional loss of significant fractions of their retinal capillaries as their disease progresses. Further yet, deficiencies in choroidal circulation are also apparent. All of these factors can be said to contribute to diabetic optic neuropathy.

Glaucoma is the second leading cause of blindness. It can be described as a group of diseases of the optic nerve that involve loss of retinal cells in a characteristic pattern of optic neuropathy. In general, it is caused by a gradual loss of blood profusion to the retina 134, particularly in those anterior portions of the retina 134 supplied by the choroidal blood flow system. The principle factor that determines local blood flow to the retina 134, and particularly to those anterior portions of the retina 134 supplied by the choroidal blood flow system, is perfusion pressure vs. intraocular pressure.

The general concept of high intraocular pressure, or more simply “high eye pressure”, (i.e., higher than 21 mmHg) is widely thought to be synonymous with glaucoma. In this context it is said to relate to problems in the drainage of an excess of intraocular fluid known as aqueous humour 144.

Aqueous humour 144 is watery fluid produced via the ciliary body 146 (i.e., tissue that mounts and controls the lens 148 and iris 150) from blood provided to it by the choroidal blood flow system. It fills the anterior portions of the eye 84 and provides pressure that bears against the vitreous humour 152 and maintains the fundamentally round shape of the globe 124. Excess aqueous humour 144 normally escapes through drainage channels and ultimately rejoins the venous system 28a/28b.

The most significant element of the drainage channels is a structure known as the filtration angle 154, which filtration angle 154 is formed between the iris 150 and the periphery of the cornea 156. Excess aqueous humour 144 passes through the filtration angle 154 and then drains through veins in the sclera 138. Generally in a healthy eye, this system is able to adjust to changes in systemic blood pressure. However, it can't do so quickly. For instance, real time measurements of eye pressure reveal significant fluctuation of eye pressure related to systolic/diastolic modulation of systemic blood pressure.

There are a number of possible mechanisms for disruption of the outflow of excess aqueous humour 144—and thus high eye pressure. One such mechanism is an excessively narrow filtration angle 154 blocking the outflow. This condition can be treated via use of a YAG laser forming a ring shaped array of small (i.e., 50 □m diameter) holes around the iris 150 to provide a supplemental leakage path for the excess aqueous humour 144.

Very low perfusion pressure can be a root cause of glaucoma as well. It is a fact that some people attain very low systemic blood pressure that simultaneously reduces their perfusion pressure to dangerously low levels during a few hours of their sleeping periods. Alternately, deficiencies in choroidal circulation can cause very low perfusion pressure as well, especially in those anterior portions of the retina 134 supplied by the choroidal blood flow system.

Otherwise, vascular tone of the various fine arteries, capillaries and veins (not shown) comprised within the retinal and choroidal blood flow systems is a factor with regard to the above described eye problems. In general, vascular tone depends upon the contractile state of smooth muscle cells and is regulated in part by endothelium-derived factors. Vascular endothelium regulates permeability, activates and inactivates hormones, affects coagulation and platelet function, as well as regulating vascular tone. Numerous chemical agents are released by the endothelial cells that contribute to the regulation of eye perfusion, such as nitric oxide, prostacycline, angiotensin, and endothelin-1.

Strikingly, almost all of the above-described eye disease conditions would seem to result at least in part from either elevated blood sugar levels, or dysfunctional blood circulation or lymph flow. Exceptions are the above-described problems with regard to drainage of excess aqueous humour 146, and very low perfusion pressure related to very low systemic blood pressure. Amazingly but not previously obvious however, virtually all of these problems would seem to be addressable at least in part by BPM therapy on the BPM machine 80.

It is believed herein that the BPM therapy eye treatment mechanism is related to modulating the varying pressure and flow gradients provided by the above-described flow of aqueous humour fluid. Aqueous humour fluid flows from the ciliary body 146 through the anterior portions of the eye 84 to and then through the filtration angle 154 and the sclera 138. It is produced by the ciliary body 146 from blood provided to it from the ophthalmic artery 118 via the choroidal blood flow system. The aqueous humour fluid exits via the filtration angle 154 into venous vessels comprised within the sclera 138, and then on through the main venous vessels 132 to the venous system 28a/28b. Thus, both the source and ultimate destination of the aqueous humour fluid are tied to portions of the circulatory system 20 located in the head 82.

As a result, it is believed herein that pressure values within the aqueous humour 144 modulate significantly in concert with motion of the bed 158. It is further believed that this modulation of aqueous humour pressure is imposed upon the vitreous humour 152 and thereby impressed upon the retina 134, main arterial vessels 130, venous vessels 132, choroidal tissue elements 140 and thus the choroidal circulatory system, and finally, against the sclera 138 itself. In addition, this modulation of aqueous humour pressure is also imposed upon the lens 148, iris 150, cornea 156 and filtration angle 154.

Thus, it is believed herein that all of the elements of the eyes 84 are subject to mechanical manipulation. It is believed that this mechanical manipulation may enable elimination of the metabolic debris as well as a general cleansing of the various arterial and venous vessels described above, thus improving vascular tone of the various fine arteries, capillaries and veins comprised within the retinal and choroidal blood flow systems. It is also believed that the function of lymph system components comprised in the eyes 84 is enhanced.

As a result, it is believed herein that macular degeneration may be reversed through BPM therapy via eliminating the metabolic debris along with improving blood and lymph flow in both the retinal and choroidal regions in order to maintain retinal pigment epithelium in a more youthful state. In fact, in recent study cases patients having wet macular degeneration and macular edema have seen their disease conditions substantially reversed as a result of utilizing BPM therapy.

Further, it should be noted that BPM therapy has been useful in clearing artery and vein occlusions and/or creating collateral profusion around them. And in general, BPM therapy has also been effective with respect to virtually all diabetic issues. Included have been wound healing, edema reduction, and neuropathy reversal as well as significant reductions in blood glucose levels and reduction of artificial insulin consumption.

It is further believed that there are amplitude and phase variations of aqueous humour pressure occurring with respect the motion of the bed 158. For instance, there may be some supplemental modulation of drainage channel resistance as it tries to regulate aqueous humour pressure. In any case, such amplitude and phase variations may yield some variation in pressure gradients across functional flow controlling orifices of the ciliary body 146 and filtration angle 154 that may contribute to cleansing of those functional flow-controlling orifices.

It is believed that a convoluted utilization of BPM therapy may be helpful in treating the above-described glaucoma-related problem of very low perfusion pressure that some people attain during a few hours of their sleeping period. The concept is for such a person to sleep overnight on a BPM machine 80 modified by the addition of a control circuit 220 described hereinbelow such that that it runs normally for a selected time period lasting perhaps tens of minutes, but is programmed to stop in its full lower extremity elevated and torso and head depressed position for the remainder of the person's sleep period. This should work because the person's aqueous humour pressure should self-regulate back to normal levels while the perfusion pressure would continue to be elevated because of the person's head down position. The control circuit 220 is configured such that it resets after the modified BPM machine 80 stops. As a result, the person is then able to restart the modified BPM machine 80 in order to bring it to its full head elevated position and then get up normally from it. Utilizing the BPM machine in this manner is deemed to be appropriate because it has been found that depletion of nutrients from the body's cells by the machine enhanced lymph system may be excessive if BPM therapy is utilized for extended time periods.

FIG. 8 is a side view of an example BPM machine 80 useful for implementing the example BPM therapy method 10. In this example, the BPM machine 80 includes a bed 158 here shown in the horizontal position. The bed 158 is configured with a torso and head-supporting portion 160, and a lower extremity-supporting portion 162 spaced generally along a horizontally disposed longitudinal axis “X”. The lower extremity-supporting portion 162 is in turn configured with a thigh-supporting portion 162a and a calf and foot-supporting portion 162b. The torso and head-supporting portion 160 is preferably angled upwards with reference to the horizontally disposed longitudinal axis “X” at an angle approximately equal to half of the selected angular range while the thigh-supporting portion 162a is preferably oppositely angled upwards at an angle approximately equal to the selected angular range, and the calf and foot-supporting portion 162b is preferably disposed in a plane nominally parallel to the longitudinal axis “X”.

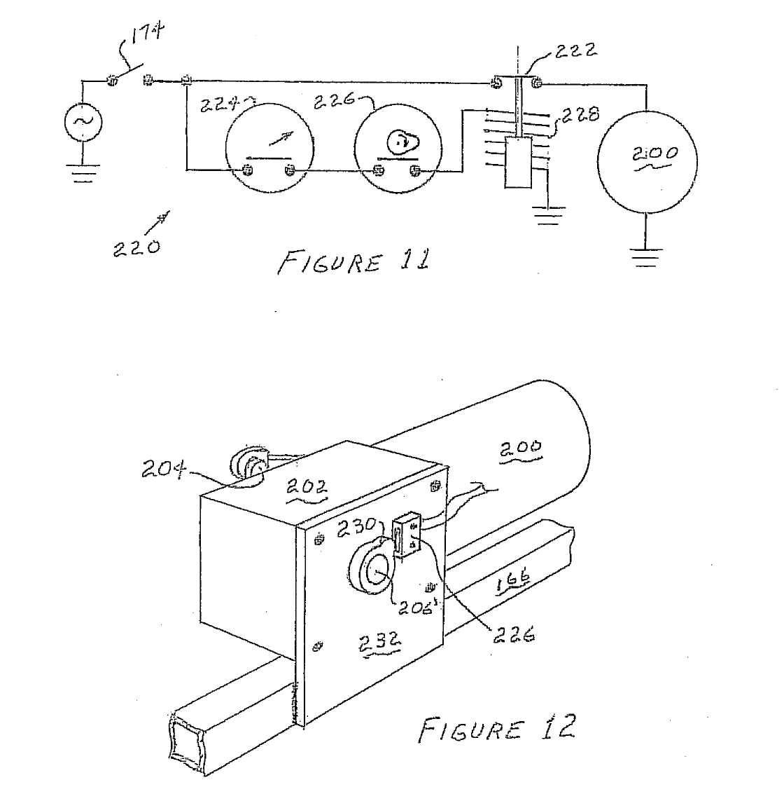

The bed 158 is pivotally mounted to a supporting frame 164. The frame 164 includes a base section 166 that supports an angled section 168. In this example, the angled section 168 includes pivots 170a and 170b that pivotally connect to a portion of the bed 158 (FIG. 10). The pivots 170a and 170b define a pivot axis “A” that is oriented in a transverse manner with respect to a vertical plane (not shown) that comprises the longitudinal axis “X”. Finally, a drive mechanism 172 is utilized for rotatably moving the bed 158 in a cyclical manner about the pivot axis “A” in accordance with selected angular range and cyclical rate values, whereby the longitudinal axis X is then operative for defining instant rotational orientations of the bed 158 around the pivot axis A (i.e., between the extreme positions depicted in FIGS. 4A and 4C).

The incorporated '033 patent depicts a Scotch yoke drive assembly 96, a crank and connecting rod mechanism 188, a servo controlled rack and pinion gear set 194, and a servo controlled hydraulic drive 196, any of which would be suitable for cyclically moving the bed 158. Because descriptive presentations of the Scotch yoke drive assembly 96, the servo controlled rack and pinion gear set 194, and the servo controlled hydraulic drive 196 have been made in the incorporated '033 patent, no further description relating to any of these types of drive mechanisms is required herein. On the other hand, the preferred example BPM machine 80 of the present invention utilizes a simplified example crank and connecting rod mechanism 178. Thus, its construction and operation is described hereinbelow with reference to FIG. 10.

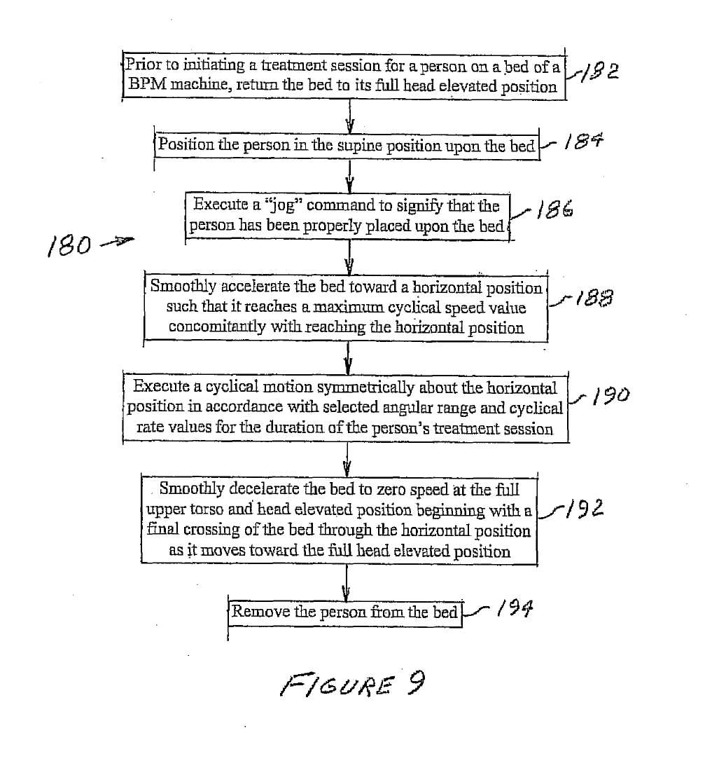

Either of the Scotch yoke drive assembly 96 shown in FIGS. 8A-C of the incorporated '033 patent, crank and connecting rod mechanism 188 shown in FIGS. 9 and 11 of the incorporated '033 patent, or the example crank and connecting rod mechanism 178 utilized in the present invention can be controlled by a simple switch such as switch 174 depicted in FIG. 8 of the present application. In the case of the incorporated '033 patent such a switch would be operative to activate and deactivate a gearmotor 98 depicted in each of FIGS. 8A-C, 9 and 11 thereof. On the other hand, either of the servo controlled rack and pinion gear set 194, or the servo controlled hydraulic drive 196 (i.e., comprising a servomotor driven pump and a hydraulic cylinder), respectively shown in FIGS. 12 and 13 of the incorporated '033 patent, could be utilized for achieving selected combinations of angular motion and cyclical rate as deemed suitable for individual persons. In either case, a controller 130 also shown and described in the incorporated '033 patent could be used for commanding appropriately selected angular range and cyclical rate values, or even for programming varying values of angular ranges and cyclical rates during treatment sessions.

FIG. 9 of the present application illustrates an example method 180 for optimally controlling a BPM machine 80 driven by either of the servo controlled rack and pinion gear set 194, or the servo controlled hydraulic drive 196 of the incorporated '033 patent, or for that matter, the example crank and connecting rod mechanism 178 utilized in the present invention but powered by a variable speed motor 176. Such optimal control can be obtained through programming controller 130 of the incorporated '033 patent for operation over a treatment session for a particular person including selected angular range and cyclical rate values in accordance with the following steps:

The first step 182 of the example method 180 is executed prior to initiating a BPM therapy session for a person 78 on the bed 158 of a BPM machine 80 and includes returning the bed 158 to its full head-elevated position in order to provide a preferred entry/exit position of the bed 158. A second step 184 includes positioning the person 78 in a supine position upon the bed. A third step 186 includes either the person 78 or a therapist executing a “jog” command signifying that the person 78 has been properly placed on the bed 158, and enabling the program to continue. A fourth step 188 includes smoothly accelerating the bed 158 toward the horizontal position such that it reaches a maximum cyclical speed value concomitantly with reaching the horizontal position. A fifth step 190 includes executing a cyclical motion symmetrically about the horizontal position in accordance with the selected angular range and cyclical rate values for the duration of the BPM therapy session.

While programming the controller 130 with a sinusoidal velocity profile for implementing the fifth step 190 certainly implements one preferred cyclical motion profile, others are possible. For instance, the modified cyclical motion of the crank and connecting rod mechanism 178 used in the preferred example BPM machine 80 of the present invention results in a non-sinusoidal velocity profile having increased lowered dwell time for the head 82 and eyes 84. If a similar modified cyclical motion is desired in a BPM machine 80 driven by either of the servo controlled rack and pinion gear set 194, the servo controlled hydraulic drive 196 of the incorporated '033 patent, or the example crank and connecting rod mechanism 178 utilized in the present invention, it can easily be accommodated by programming the controller 130 with a velocity profile having both sinusoidal and even harmonics.

In any case, stopping the BPM machine 80 in accordance with a sixth step 192 includes smoothly decelerating the bed 158 to zero speed at its preferred full head-elevated entry/exit position, beginning with a final crossing of the bed 158 through the horizontal position as it moves toward the head-elevated position. And finally, a seventh step 194 includes removing the person 78 from the bed 158 in order to terminate the BPM therapy session. Given this description, one of ordinary skill in the art will recognize and be able to generate command sequences for obtaining suitable combinations of acceleration/deceleration characteristics, other treatment angular range and cyclical rate values, or varying values of angular ranges and cyclical rates during treatment sessions in order to meet the needs of particular persons.

Shown in FIG. 10 is a perspective view of the drive mechanism 172 with a cover 196 shown in FIG. 8 removed. In this example, the drive mechanism 172 includes a gearmotor 198 comprising a motor 200 and a speed-reducing gearbox 202 driving the afore-mentioned example crank and connecting rod mechanism 178. The crank and connecting rod mechanism 178 includes a crank 204 driven via an output shaft 206 of the speed-reducing gearbox 202. The crank 204 engages a connecting rod 208 that is pivotally connected to a drive arm 210 that extends from the bed 158. In this case the switch 174 (not shown in FIG. 10) is operative to activate and deactivate the motor 200 and thus the drive mechanism 172. It is true that the drive mechanism 172 is capable of only providing a single valued angular range unless equipped with a variable speed motor 176 and suitable electrical drive therefor (not shown). Unless so equipped however, it does have the advantage of including readily available components such as the gearmotor 198 and switch 174. Therefore, it follows that a BPM machine 80 comprising the example drive mechanism 172 can be quickly and economically developed, and may in fact, be more economical to produce. This could be important because it would be desirable to produce BPM machines 80 in large volumes for home use by persons for enhancing blood circulation as well as intraocular, lymph and neural fluid flows within their eyes with the aim of relieving symptoms of macular edema, macular degeneration, glaucoma, diabetic retinopathy, and retinal artery and vein occlusions.

Surprisingly, there is also an advantage in not utilizing a controller such as the controller 130 shown and described in the incorporated '033 patent. This is because such controllers typically utilize a bridge circuit comprising solid state switching devices that are usually relatively unshielded and therefore a source of high frequency electromagnetic radiation that is considered to be undesirable by a significant percentage of potential users of the example BPM machine 80. In fact, such high frequency electromagnetic radiation could conceivably be dangerous for individuals using pacemakers. Thus, utilization of the drive mechanism 172 as controlled by the simple switch 174 comprised in the example BPM machine 80 is considered herein to be preferable.

In the example drive mechanism 172 the gearmotor 198 serves to rotate the crank 204. Rotation of the crank 204 cyclically moves the connecting rod 208 back and forth along an undulating thrust axis “Y” in order to position and exert necessary forces on the drive arm 210 as required for it to cyclically move the bed 158 rotatably in a seesawing manner about the pivot axis “A”. The resulting cyclical motion of the bed 158 alternately elevates the head 82, and then the lower extremities 86 of a person 78 lying on the bed 158 in the cyclical manner described hereinbefore. As described above, can be appreciated, the length of the crank 204 can either be designed for a larger or smaller stroke of the drive arm 210 and resulting angular range values, or even be configured in the manner of adjustable length crank arm 100 of the incorporated '033 patent in order to attain selected angular range values.

Shown in FIG. 11 is a schematic view of a control circuit 220 utilized for selectively stopping the motor 200 and thus the cyclical motion of the modified BPM machine 80 when it is utilized for treating the above-described glaucoma-related problem of very low perfusion pressure that some people attain during a few hours of their sleeping period. The control circuit 220 comprises the switch 174 being wired in series with a normally closed contactor 222 and the motor 200, and also being wired in series with a timer 224, a cam follower activated switch 226 and an activation coil 228 of the contactor 222. The contactor 222 is activated (i.e., opened) whenever the activation coil 228 is energized via simultaneous switch contact closures in the timer 224 and the cam follower activated switch 226. The timer 226 is activated whenever the switch 174 is closed and resets whenever the switch 174 is opened.

Thus, the motor 200 is activated via closure of the switch 174 and runs until either the switch 174 is opened again, or until both of the switch contacts in the timer 224 and the cam follower activated switch 226 are simultaneously closed and activate the activation coil 228 of the contactor 222, thereby rendering the contactor 222 in its open contact state and stopping the motor 200. Then later after the person 78 wakes up, he or she simply turns off the switch 174 in order to reset the timer 226 and then switches the switch 174 back on again in order to bring the bed 158 to its full head-elevated position so that he or she can get off of the bed 158 in the normal fashion.

Shown in FIG. 12 is a perspective view of a modified speed-reducing gearbox 202′ with a modified output shaft 206′ having a cam feature 230 with a selected dwell angle. The cam follower activated switch 226 is mounted on upon a gearmotor mounting plate 232, the gearmotor mounting plate 232 being included in the base section 166 of the frame 164. The cam feature 230 is positioned on the gearmotor output shaft 206 in a known angular orientation relative to the crank 204 whereby the relative positions of the cam follower activated switch 226 and the cam feature 230 are such that the cam follower activated switch 226 closes just prior to the time the bed 158 arrives at the extreme lowered head position depicted in FIG. 4C (e.g., when its lower extremity portion 162 is fully elevated and its torso and head-supporting portion 160 is fully depressed) whereby the gearmotor 198 achieves a fully stopped condition at the extreme lowered head position depicted in FIG. 4C, and further where the selected dwell angle is larger than any possible coasting angle thus guaranteeing no “coast over” and restarting of the motor 200. Given these descriptions, one of ordinary skill in the art will recognize several variations in providing suitable drive mechanisms and drive modes for cyclically moving and/or selectively stopping the motion of the bed 158.

Although preferred embodiments of this invention have been disclosed, workers of ordinary skill in the various arts associated with this invention would recognize that certain modifications would come within the scope of this invention. For instance, BPM therapy could be utilized for treating other eye diseases or conditions not named above. Also, the construction details of the BPM machine 80 could be altered without deviating from the spirit of this invention. By way of example, a modified bed 158′ could comprise independent torso and head, and lower extremity supporting portions capable of pivoting or rotating relative to each other. These could for instance, be utilized for altering the contoured shape of the bed 158. In another example, the speed-reducing gearbox 202 could be replaced by the combination of a hydraulic pump and hydraulic motor whose output shaft would then be utilized for driving the crank 204. And in yet another example, electronic apparatus comprising an optical encoder or another type of electronic angular measuring device along with suitable electronic switching devices could be substituted for the control circuit 220 described above. For that reason, the following claims should be studied to determine the true scope and content of this invention.

What is claimed is:

1. A method for therapeutic treatment of a disease or ailment condition of the eyes through the use of blood pressure modulation (BPM) therapy, said method comprising the steps of:
providing a BPM apparatus comprising:
a bed configured to retain a person thereupon in a supine manner generally along a longitudinal axis such that said person's head are longitudinally spaced apart from said person's lower extremities;
said BPM apparatus further including a supporting frame for pivotingly supporting said bed about a transversely disposed pivot axis nominally orthogonal to a vertical plane comprising said longitudinal axis, said longitudinal axis of said bed then being operative for defining instant rotational orientations of said bed around said pivot axis;
said BPM apparatus further including a motor; and
a drive mechanism for selectively coupling said motor to said bed;
wherein said motor is energizable for rotatably and cyclically moving said bed about said pivot axis;
disposing a person on said bed so that said person lies supinely thereupon with his or her head, and lower extremities spaced apart generally along said longitudinal axis; and
energizing said motor so as to activate said BPM apparatus and thereby rotatably move said bed about said pivot axis through many cycles wherein said person's lower extremities are raised to a level higher than said person's head, and vice-versa during each cycle;
wherein each cycle causes a modulation of the person's blood pressure whereby resulting multiple blood pressure modulation and/or switching events cause compression and stretching of the tissue comprised in the person's head and eyes, and
wherein said multiple venous blood pressure modulation and/or switching events result in cumulative internal massaging of arteries and fine arteries, veins and fine veins, neural fluid flow channels, and lymph fluid flow channels in the person's head and eyes.

2. The method as set forth in claim 1, wherein the angular range of motion of said longitudinal axis of said bed, and said person, about said pivot axis is between 10° and 60°.

3. The method as set forth in claim 2, wherein the selected angular range of motion of said longitudinal axis of between 10° and 60° extends symmetrically to either side of a nominally centered horizontal position.

4. The method as set forth in claim 2, wherein said longitudinal axis of said bed, and said person, are moved through an angular range of motion of about 30°.

5. The method as set forth in claim 4, wherein the selected angular range of motion of about 30° extends symmetrically to either side of a nominally centered horizontal position.

6. The method as set forth in claim 1, wherein the cyclical rate utilized for rotatably and cyclically moving said longitudinal axis of said bed, and said person, about said pivot axis is between 2 cycles/minute and 10 cycles/minute.

7. The method as set forth in claim 6, wherein the cyclical rate utilized for rotatably and cyclically moving said longitudinal axis of said bed, and said person, about said pivot axis is about 6 cycles/minute.

8. The method as set forth in claim 1, wherein the product of the angular range of motion of said longitudinal axis of said bed and the cyclical rate utilized for rotatably and cyclically moving said longitudinal axis of said bed is between 90 degree-cycles/minute and 270 degree-cycles/minute.

9. The method as set forth in claim 8, wherein the product of the angular range of motion of said longitudinal axis of said bed and the cyclical rate utilized for rotatably and cyclically moving said longitudinal axis of said bed is about 180 degree-cycles/minute.

10. The method as set forth in claim 1, further including said drive mechanism being selected from the group comprising a Scotch yoke mechanism, a crank and connecting rod mechanism, a linear drive mechanism, and a hydraulic drive mechanism.

11. The method as set forth in claim 10, wherein said drive mechanism includes said crank and connecting rod mechanism.

12. The method as set forth in claim 1, wherein said bed is configured such that when said longitudinal axis of said bed is disposed in a centered position, the torso and head supporting portion thereof is angled upwards with reference to said longitudinal axis at an angle approximately equal to half of the selected angular range while the thigh supporting portion thereof is oppositely angled upwards with reference to said longitudinal axis at an angle approximately equal to the selected angular range, and the calf and foot supporting portion thereof is disposed in a plane nominally parallel to said longitudinal axis.

13. The method as set forth in claim 1, wherein the disease or ailment condition is from among the group comprising macular edema, macular degeneration, glaucoma, diabetic retinopathy, and retinal artery and/or vein occlusions.

14. The method as set forth in claim 1, wherein the disease or ailment condition is macular edema.

15. The method as set forth in claim 1, wherein the disease or ailment condition is macular degeneration.

16. The method as set forth in claim 1, wherein the disease or ailment condition is glaucoma.

17. The method as set forth in claim 1, wherein the disease or ailment condition is diabetic retinopathy.

18. The method as set forth in claim 1, wherein the disease or ailment condition is retinal artery occlusions.

19. The method as set forth in claim 1, wherein the disease or ailment condition is retinal vein occlusions.

20. The method as set forth in claim 1, wherein the disease or ailment condition is glaucoma, and wherein the method results in significant modulation of eye pressure during each cycle of operation of said BPM apparatus.

21. The method as set forth in claim 20, wherein the significant modulation of eye pressure during each cycle of operation of said BPM apparatus serves to keep aqueous humour drainage channels free of debris and thus free flowing.

22. The method as set forth in claim 21, wherein the aqueous humour drainage channels comprise filtration angles formed between the iris and the edges of the cornea of the eyes.

23. The method as set forth in claim 21, wherein the aqueous humour drainage channels comprise a ring shaped array of small (i.e., 50 μm diameter) holes formed around the iris to provide a supplemental leakage path for the excess aqueous humour.

24. The method as set forth in claim 1, wherein the disease or ailment condition is glaucoma resulting from dangerously low perfusion pressure as enabled by low systemic blood pressure during a few hours of a person's sleeping periods, and wherein the method additionally comprises the step of:
energizing said motor for a selected time period lasting perhaps tens of minutes, but stopping it with said BPM apparatus in its full lower extremity elevated and torso and head depressed position for the remainder of the person's sleep period.

25. The method as set forth in claim 24, wherein maintaining said BPM apparatus in its full lower extremity elevated and torso and head depressed position serves to maintain adequate perfusion pressure for enabling blood flow into the retina from said person's choroidal blood flow system for the remainder of the person's sleep period.

26. The method as set forth in claim 1, wherein the method additionally comprises the steps of:
locating the BPM apparatus in a relatively isolated and quite environment; and
maintaining a comfortable and relaxed state of the person.

27. The method as set forth in claim 26, wherein maintaining the comfortable and relaxed state of the person comprises avoiding any contact with the person (i.e., such as talking to him or her) with the purpose of inducing him or her into a state of sleeping.

28. The method as set forth in claim 26, wherein maintaining the comfortable and relaxed state of the person comprises engaging in quiet and relaxing conversation with a person for the purpose of calming him or her if he or she exhibits hyperactivity, hypersensitivity or hyperirritability symptoms.

29. The method as set forth in claim 26, wherein maintaining the comfortable and relaxed state of the person comprises choosing a combination of annular range and cyclical rate for rotatably and cyclically moving said bed about said pivot axis that precludes dizziness or other discomforts in the person.

30. The method as set forth in claim 29, wherein the combination of annular range and cyclical rate for rotatably and cyclically moving said bed about said pivot axis is between 90 degree-cycles/minute and 270 degree-cycles/minute.

31. The method as set forth in claim 30, wherein the combination of annular range and cyclical rate for rotatably and cyclically moving said bed about said pivot axis is about 180 degree-cycles/minute.

32. A method for the treatment of a disease or ailment condition of the eyes through the use of venous blood pressure modulation (BPM) therapy, said method comprising the steps of:
providing a BPM apparatus comprising:
a bed configured to retain a person thereupon in a supine manner generally along a longitudinal axis such that said person's head are longitudinally spaced apart from said person's lower extremities;
said BPM apparatus further including a supporting frame for pivotingly supporting said bed about a transversely disposed pivot axis nominally orthogonal to a vertical plane comprising said longitudinal axis, said longitudinal axis of said bed then being operative for defining instant rotational orientations of said bed around said pivot axis;
said BPM apparatus further including a controller;
said BPM apparatus further including a variable speed motor that is operatively connected to and driven by a power signal issued from said controller;
a drive mechanism for selectively coupling to said variable speed motor to said bed; and
said BPM apparatus further including position measuring apparatus operatively connected to said bed and said controller, said position measuring apparatus issuing a position signal indicative of rotational positions of said longitudinal axis to said controller;
wherein said variable speed motor is energizable by said controller operating in a closed-loop manner via issuing a controlled power signal to said servomotor such that said position signal can be maintained in close conformance with a command signal representative of a selected program for rotatably and cyclically moving said bed about said pivot axis;
disposing a person on said bed so that said person lies supinely thereupon with his or her head, and lower extremities spaced apart generally along said longitudinal axis; and
energizing said motor so as to activate said BPM apparatus and thereby rotatably move said bed about said pivot axis through many cycles wherein said person's lower extremities are raised to a level higher than said person's head, and vice-versa during each cycle;
wherein each cycle causes a modulation of the person's blood pressure whereby resulting multiple blood pressure modulation and/or switching events cause compression and stretching of the tissue comprised in the person's head and eyes, and
wherein said multiple venous blood pressure modulation and/or switching events result in cumulative internal massaging of arteries and fine arteries, veins and fine veins, neural fluid flow channels, and lymph fluid flow channels in the person's head and eyes.

33. The method as set forth in claim 32, further including said drive mechanism being selected from the group comprising a linear drive mechanism and a hydraulic drive mechanism.

34. The method as set forth in claim 32, wherein said command signal is configured in accordance with the method additionally comprising the steps of:
prior to initiating a treatment session, returning said bed to its full head-elevated position;
after the person has been positioned in a supine position upon the bed, executing a “jog” command signifying that said person has been properly placed on said bed;
smoothly accelerating said bed toward the horizontal position such that it reaches a maximum cyclical speed value concomitantly with reaching the horizontal position;
executing a cyclical motion symmetrically about said horizontal position in accordance with selected angular range and cyclical rate values for the duration of the treatment session;
smoothly decelerating said bed to zero speed at its full head-elevated position, beginning with a final crossing of said bed through the horizontal position as it moves toward the head-elevated position; and
removing said person from said bed in order to terminate said treatment session.

35. A method by which a person subject to having very low systemic blood pressures and therefore very low eye profusion pressures during periods of sleep would be able to achieve adequate nourishment for the retinas of his or her eyes, said method comprising the steps of:
providing a BPM apparatus enabled for cyclic operation for a selected time period lasting perhaps tens of minutes, but then stopping it with said BPM apparatus in its full torso and head depressed position;
placing the person on the bed of the BPM machine;
activating it for cyclic motion for a selected time period lasting perhaps tens of minutes; and
stopping it with said BPM apparatus in its full lower extremity elevated and torso and head depressed position for the remainder of the person's sleep period.

36. A control circuit for selectively terminating the cyclical motion of a BPM apparatus having a drive motor, comprising:
a switch;
a normally closed contactor having normally closed contacts and an activation coil;
a normally open timer; and
a cam follower activated switch;
wherein said switch is wired in series with said normally closed contacts of said normally closed contactor and said motor, and said timer and said cam follower activated switch are wired in series with said activation coil of said normally closed contactor;
further wherein said switch is closed to initiate said cyclical motion of said BPM apparatus via activation of said drive motor; and
still further wherein said cyclical motion of said BPM apparatus is terminated whenever contact closures simultaneously occur in said timer and said cam follower activated switch, whereby said activation coil of said normally closed contactor is activated thereby opening said normally closed contacts of said normally closed contactor, and thereby deactivating said motor and terminating said cyclical motion of said BPM apparatus.

37. The control circuit of claim 36, further wherein the normally open timer resets to its normally open condition whenever said switch is opened;
whereby a person can restart said motor thus enabling return of said BPM apparatus to its torso and head elevated position via opening and then closing said switch.

38. The control circuit of claim 36, further comprising a cam positionally coupled to the cyclical motion of said BPM apparatus;
wherein said cam follower activated switch is located proximate to said cam such that it is activated by said cam whenever said BPM apparatus attains its full torso and head depressed position;
whereby upon activation of said timer, said control circuit deactivates said motor and terminates said cyclical motion of said BPM apparatus at the torso and head depressed position.

39. A method for therapeutic treatment of a glaucoma-related problem of very low perfusion pressure that some people attain during a few hours of their sleeping period through the use of blood pressure modulation (BPM) therapy, said method comprising the steps of:
providing a BPM apparatus comprising:
a bed configured to retain a person thereupon in a supine manner generally along a longitudinal axis such that said person's head is longitudinally spaced apart from said person's lower extremities;
said BPM apparatus further including a supporting frame for pivotingly supporting said bed about a transversely disposed pivot axis nominally orthogonal to a vertical plane comprising said longitudinal axis, said longitudinal axis of said bed then being operative for defining instant rotational orientations of said bed around said pivot axis including limiting positions whereat the person's head is fully elevated and fully lowered;
said BPM apparatus further including a motor;
a drive mechanism for selectively coupling said motor to said bed; and
a control circuit;
wherein said control circuit is configured for energizing said motor for rotatably and cyclically moving said bed about said pivot axis for a selected time period and then stopping said motor when said bed arrives at a rotational orientation whereat said person's head is fully lowered until said control circuit is reset; and
disposing a person on said bed so that said person lies supinely thereupon with his or her head, and lower extremities spaced apart generally along said longitudinal axis;
energizing said motor so as to activate said BPM apparatus and thereby rotatably move said bed through multiple cycles about said pivot axis during said selected time period wherein said person's lower extremities are raised to a level higher than said person's head, and vice-versa during each cycle; and
stopping said motor after said selected time period has elapsed at said rotational orientation whereat said person's head is fully lowered;
wherein after said selected time period has elapsed and at said rotational orientation whereat said person's head is fully lowered, said person's aqueous humour pressure self-regulates back to normal levels even as said person's perfusion pressure is somewhat elevated because of his or her head being fully lowered.

40. The method as set forth in claim 39, said method comprising the additional steps of:
providing said control circuit with:
a switch;
a normally closed contactor having an activation coil;
a timer; and
a cam follower activated switch;
wherein said switch is wired in series with said normally closed contactor and said motor; and
further wherein said switch is also wired in series with switch contacts in said timer and said cam follower activated switch, and said activation coil of said normally closed contactor; and
providing said drive mechanism with a cam feature for activating said cam follower activated switch at said rotational orientation whereat said person's head is fully lowered;
whereby said control circuit is enabled for energizing said motor for rotatably and cyclically moving said bed about said pivot axis for a selected time period and then stopping said motor when said bed arrives at a rotational orientation whereat said person's head is fully lowered until said control circuit is reset.

41. BPM apparatus comprising:
a bed configured to retain a person thereupon in a supine manner generally along a longitudinal axis such that said person's head is longitudinally spaced apart from said person's lower extremities;
said BPM apparatus further including a supporting frame for pivotingly supporting said bed about a transversely disposed pivot axis nominally orthogonal to a vertical plane comprising said longitudinal axis, said longitudinal axis of said bed then being operative for defining instant rotational orientations of said bed around said pivot axis including limiting positions whereat the person's head is fully elevated and fully lowered;
said BPM apparatus further including a motor;
a drive mechanism for selectively coupling said motor to said bed; and
a control circuit;
wherein said control circuit is configured for energizing said motor for rotatably and cyclically moving said bed about said pivot axis for a selected time period and then stopping said motor when said bed arrives at a rotational orientation whereat said person's head is fully lowered until said control circuit is reset.

42. The BPM apparatus as set forth in claim 41, further comprising:
said control circuit having:
a switch;
a normally closed contactor having an activation coil;
a timer; and
a cam follower activated switch;
wherein said switch is wired in series with said normally closed contactor and said motor; and
further wherein said switch is also wired in series with switch contacts in said timer and said cam follower activated switch, and said activation coil of said normally closed contactor; and
said drive mechanism having a cam feature for activating said cam follower activated switch at said rotational orientation whereat said person's head is fully lowered;
whereby said control circuit can be enabled for energizing said motor for rotatably and cyclically moving said bed about said pivot axis for a selected time period and then stopping said motor when said bed arrives at a rotational orientation whereat said person's head is fully lowered until said control circuit is reset.
